(19) United States
(12) Patent Application Publication
(10) Pub. No.: US 2025/0028626 A1
(43) Pub. Date: Jan. 23, 2025

(54) INTELLIGENT RUN-TIME COMPLICATION IDENTIFICATION AND SOLUTIONS FOR A CODEBASE

(71) Applicant: AppLand Inc., Weston, MA (US)

(72) Inventors: Elizabeth Lawler, Weston, MA (US); Kevin Gilpin, Weston, MA (US)

(21) Appl. No.: 18/356,428

(22) Filed: Jul. 21, 2023

(51) Int. Cl. G06F 11/36

(52) U.S. Cl. CPC G06F 11/3612; G06F 11/362

(57) ABSTRACT

Systems, methods, and devices are provided to intelligently identify run-time complications within a codebase and provide recommended solutions for the identified run-time complications. A behavioral model of the codebase is accessed that depicts a run-time behavior of the codebase. The behavioral model generated is then interrogated to predict run-time complications within the codebase. Recommended solutions are generated and provided in a user interface for resolving the run-time complications.

### CROSS REFERENCE TO RELATED APPLICATIONS

This application is related to contemporaneously filed U.S. Patent Application entitled “INTELLIGENT INTERROGATION AND TAGGING OF A CODEBASE AND CORRESPONDING BEHAVIORAL MODEL,” Attorney Docket No. 717.0004, the contents of which is incorporated by reference in its entirety for all purposes.

### TECHNICAL FIELD

Aspects of the disclosure are related to the field of computer software applications and in particular to intelligently identifying run-time complications within a codebase and providing recommended solutions for the identified run-time complications, along with the associated technology.

### BACKGROUND

Typical methods to identify complications within a codebase of a software application rely on static or dynamic analysis of the codebase. Static analysis methods examine the codebase without executing the software application. This process provides an understanding of the code structure to ensure that the codebase is meeting typical industry standards. Dynamic analysis methods examine the codebase while the application is running to identify complications apparent in operation. Dynamic analysis is performed in a testing environment prior to software release. By analyzing the codebase directly, these methods can separately identify static and dynamic software issues, respectively.

Currently, programming organizations maintain high quality code through various methods. Prior to complication identification, these organizations implement rules delineating how one can program, coding architectures programmers must abide by, along with modules programmers must use. In addition to these development methods, programming organizations also utilize both static and dynamic analysis tools, separately, to identify complications within the codebase.

Although useful, static analysis tools and dynamic analysis tools are unable to identify complications that become evident at production scale. Static analysis primarily identifies context-related bugs, and dynamic analysis is subject to strain that is limited to a testing environment. So, although these analysis techniques make up for some shortcomings of the other, current development and analysis tools do not combine the power of both, nor are they capable of identifying production level run-time complications. Thus, programmers are required to implement separate development tools to analyze the codebase in either the static or dynamic state and wait for production implementation to get bug reports on production run-time complications.

### Overview

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method that includes accessing a behavioral model of a codebase, where the behavioral model represents a run-time behavior of the codebase generated based on a run-time analysis of the codebase. The method also includes interrogating the behavioral model to predict run-time complications within the codebase. The method also includes generating a recommended solution for at least one of the run-time complications. The method also includes providing a user interface that includes the behavioral model, a listing of the run-time complications, and the recommended solution. Other embodiments of this aspect include corresponding computer systems, apparatus, and computer programs recorded on one or more computer storage devices, each configured to perform the actions of the methods.

Implementations may include one or more of the following features. The method may include interrogating the behavioral model by identifying problem patterns within the codebase. In some embodiments, the run-time complications may include design flaws that become apparent in production during run-time. In some embodiments, interrogating the behavioral model further includes applying artificial intelligence that can recommend solutions to the design flaws based on the behavioral model of the codebase. In some embodiments, the method may include generating the behavioral model based on recording an execution of the codebase. In some embodiments, run-time complications may include a memory leak, inefficient data access, improper access control, or the like. In some embodiments, interrogating the behavioral model may include assigning a probability score to each of the run-time complications based on a probability that the respective run-time complication will arise in production during run-time. In some embodiments, interrogating the behavioral model may include ranking the run-time complications based on the probability score and ordering, in the user interface, the run-time complications based on the ranking. In some embodiments, the recommended solution may include a code snippet to replace a portion of the codebase that includes a design flaw that causes at least one of the run-time complications. Implementations of the described techniques may include hardware, a method or process, or computer software on a computer-accessible medium.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates a logical data flow for an intelligent run-time complication identifier for a codebase, according to some embodiments.

FIG. 2 illustrates an exemplary computing system for an intelligent run-time complication identifier for a codebase in a local implementation for downloadable embodiments.

FIG. 3 illustrates an exemplary cloud-based system for an intelligent run-time complication identifier for a codebase, according to some embodiments.

FIGS. 4A and 4B illustrate exemplary visual depictions of a codebase behavioral model, according to some embodiments.

FIG. 5A illustrates a user interface for an intelligent run-time complication identifier for a codebase, according to some embodiments.

FIG. 5B illustrates a user interface pop-up window for an intelligent run-time complication identifier for a codebase, according to some embodiments

FIG. 5C illustrates an updated user interface for an intelligent run-time complication identifier for a codebase, according to some embodiments.

FIG. 6 illustrates a method for identifying run-time complications and providing recommended solutions, according to some embodiments.

FIG. 7 illustrates a computing system suitable for implementing the various operational environments, architectures, processes, scenarios, and sequences discussed below with respect to the other Figures.

### DETAILED DESCRIPTION

Various implementations are disclosed herein that describe technology for identifying run-time complications within a codebase and providing recommended solutions to mitigate at least one of the identified run-time complications. In many situations, software applications may include design flaws that are difficult to identify and that create run-time complications that are difficult to diagnose. For example, a codebase may include poorly designed code that results in memory leaks, inefficient data access, improper access control, or the like. A typical debugger may not identify the inefficient data access, the memory leaks, improper access control, or the like based on a static analysis or dynamic analysis. For example, a memory leak or inefficient data access may not be identified until the application is running in production with a production-level amount of strain and users, and the poorly designed portion of the code is called a sufficient number of times. Additionally, until a sufficient number of users with varying privileges access the application, one may not find that he or she can or cannot access certain data as expected to identify the improper access control. Similarly, other poorly designed code may not be apparent prior to production-level use.

To address these types of issues, the intelligent run-time complication identifier identifies run-time complications within a codebase by accessing a behavioral model of the codebase that depicts the run-time behavior of the codebase based on a run-time analysis of the codebase. The run-time complication identifier interrogates the behavioral model to identify run-time complications within the codebase. For at least one identified run-time complication, the run-time complication identifier generates a recommended solution. The recommended solution may include, for example, a code snippet to replace the identified run-time complication in the codebase, information about the type of design flaw, information for fixing the particular design flaw, and/or other information related to the run-time complication. The recommended solution may be provided via a pop-up window in the user interface, redirection to a different page in the user interface, redirection to an external website, or the like. The run-time complication identifier may include a user interface that may provide visual depictions of behavioral models, listings of run-time complications, and access to recommended solutions.

In some implementations, the run-time complication identifier may be software that can be downloaded and executed on a server. In some implementations, the run-time complication identifier may be a cloud-based service hosted by a service provider. In a cloud-based service implementation, online services to intelligently identify the run-time complications within the codebase are provided and a user interface is hosted that provides visualizations for the user to access.

Implementations of the technology described herein provide various advantages over the available technologies. Run-time complications that would not be identified prior to deploying in production can be identified, saving human capital time, human capital resources, processor and memory resources, and application downtime. Further, the run-time complications can be pinpointed without waiting for production downtime to perform post-issue root-cause analysis. Instead, the root-cause of issues are identified prior to the run-time complication in a production environment. A recommended solution is further provided to enhance the speed at which the fix is implemented. Additionally, the application of an analyzer that identifies static and dynamic complications within the codebase are performed simultaneously without the use of separate static and dynamic analyzers. A dynamic analysis of the codebase is completed based on analyzing the behavior model of the codebase, and a static analysis of the codebase is also performed based on identifying problem patterns within the model.

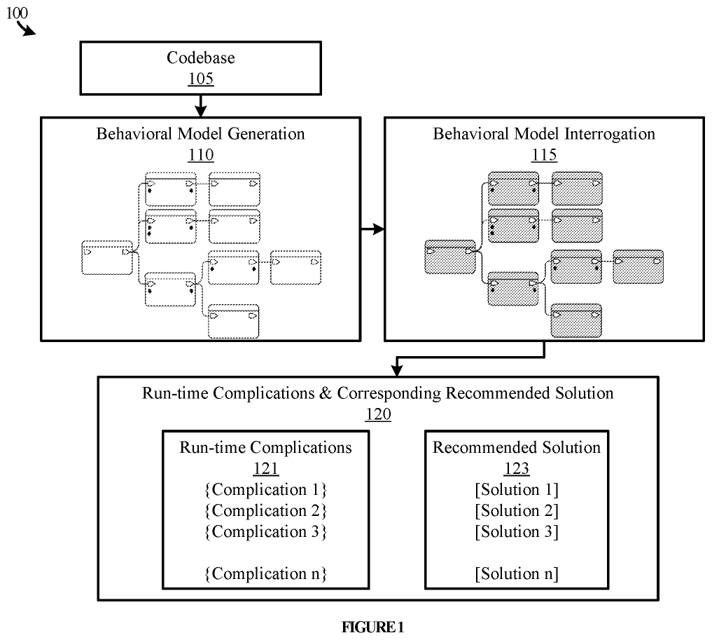

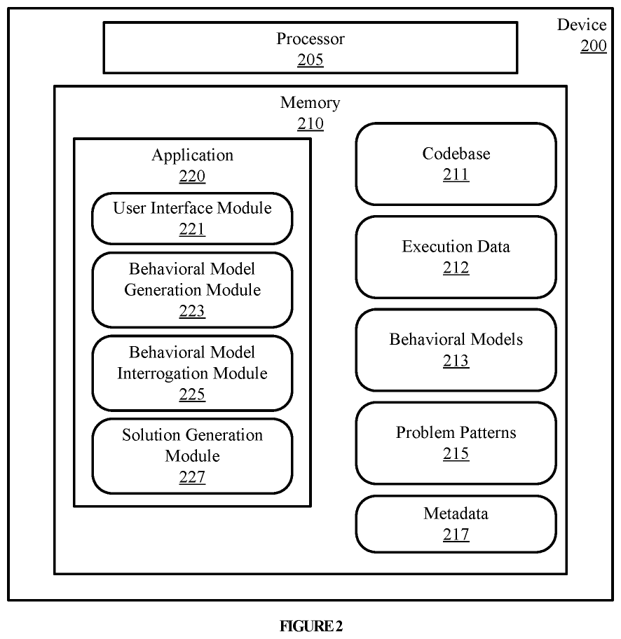

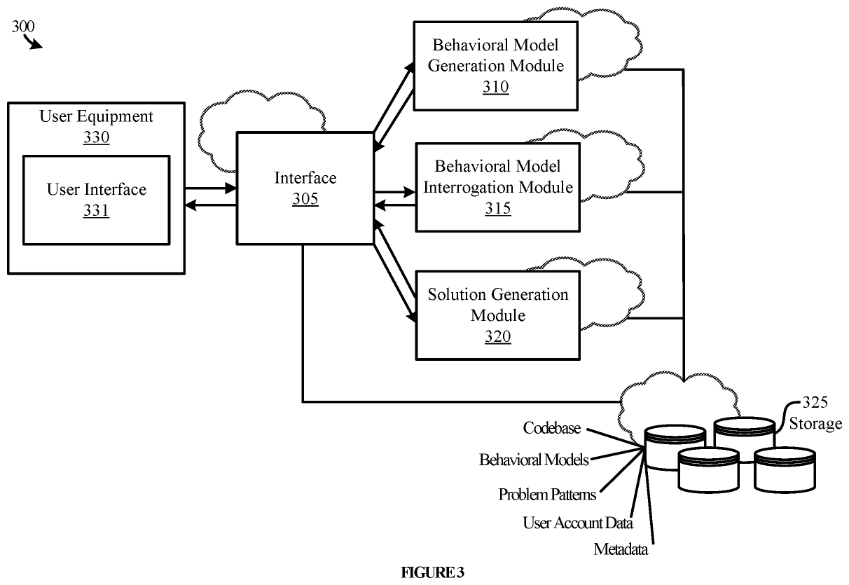

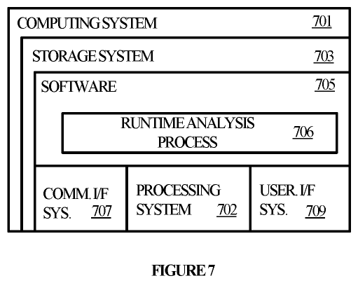

Turning to the figures, FIG. 1 describes logical data flow 100, for an intelligent run-time complication identifier in an implementation. Logical data flow 100 includes codebase 105, behavioral model generation 110, behavioral model interrogation 115, and run-time complications & corresponding recommended solution 120. Logical data flow 100 may be implemented in hardware, software, and/or firmware, and in the context of one or more computing systems, of which computing device 701 of FIG. 7 is representative. Logical data flow 100 may be implemented on a variety of systems including both local and cloud-based systems, which are further described in FIG. 2 and FIG. 3, respectively.

In an implementation, codebase 105 represents a source code codebase for a software application. Software applications represented by codebase 105 can include locally installed applications on a personal computer, locally installed applications on a server, applications served from a cloud, web applications, apps for installation on a mobile device, or the like. Codebase 105 may be written in any coding language, such as, for example JAVA, RUBY, C, C++, FORTRAN, PYTHON, JAVASCRIPT, or the like.

Behavioral model generation 110 generates a behavioral model based on a run-time analysis of codebase 105. In other words, the behavioral model produced by behavioral model generation 110 represents a run-time behavior of the codebase 105. Behavioral model generation 110 may include functionality to execute codebase 105 to generate one or more trace files that detail the behavior of codebase 105 in operation. In some embodiments, codebase 105 may include more than one codebase. For example, codebase 105 may include code executed on a backend server as well as code executed on a user device and/or other machines that all work together to form a single software system. Behavioral model generation 110 may be performed in any suitable environment but is typically performed prior to release of the codebase 105 to a production environment so as to identify any run-time complications prior to release. For example, executing codebase 105 to generate the behavioral model may be done in a pre-production environment, in a development container, in a testing environment, in a Continuous Integration (CI) environment, or the like.

The execution of codebase 105 may be performed exhaustively using one or more of a number of different techniques including using artificial intelligence (e.g., machine learning models) to probe codebase 105, and using test scripts to probe codebase 105. For example, test cases that probe codebase 105 may be generated and automatically executed and the execution of the codebase 105 using the test cases may be recorded to generate trace files. The test cases may include recording each server request including HyperText Transport Protocol (HTTP) server requests. As another example, the trace files may be generated based on recording human interaction with the executing codebase 105 (e.g., a user may run codebase 105 and interact with a user interface generated by execution of codebase 105). The trace files may include all threads of execution including background jobs, message queue activity, server requests (e.g., HTTP server requests, database server requests, etc.), and the like. As another example, isolated code blocks of codebase 105 may be executed to generate the trace files. The isolated code blocks may include, for example, a Ruby block, a Java Runnable, or a Python context manager (e.g., with statement). The isolated code block may include any number of lines of code from codebase 105. As another example, the trace files may be generated based on one or more processes performed during execution of codebase 105. Processes may include, for example, a login/authentication process, a data submission process (e.g., submission of data entered by a user into a user interface), or any other process. As another example, the trace files may be generated based on synthetic traffic generated to simulate a number of users accessing the executing codebase 105 as may be seen in a production environment. For example, a simulation engine may be used to generate the synthetic traffic.

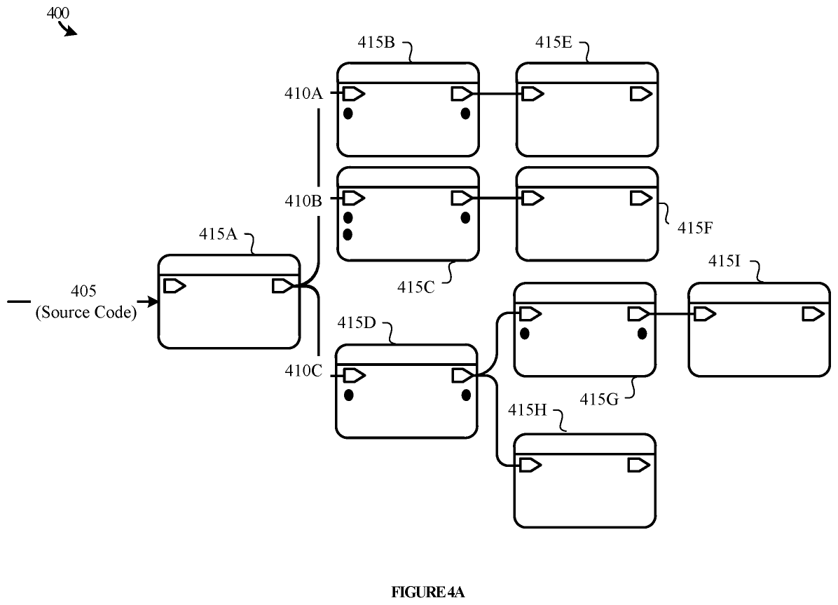

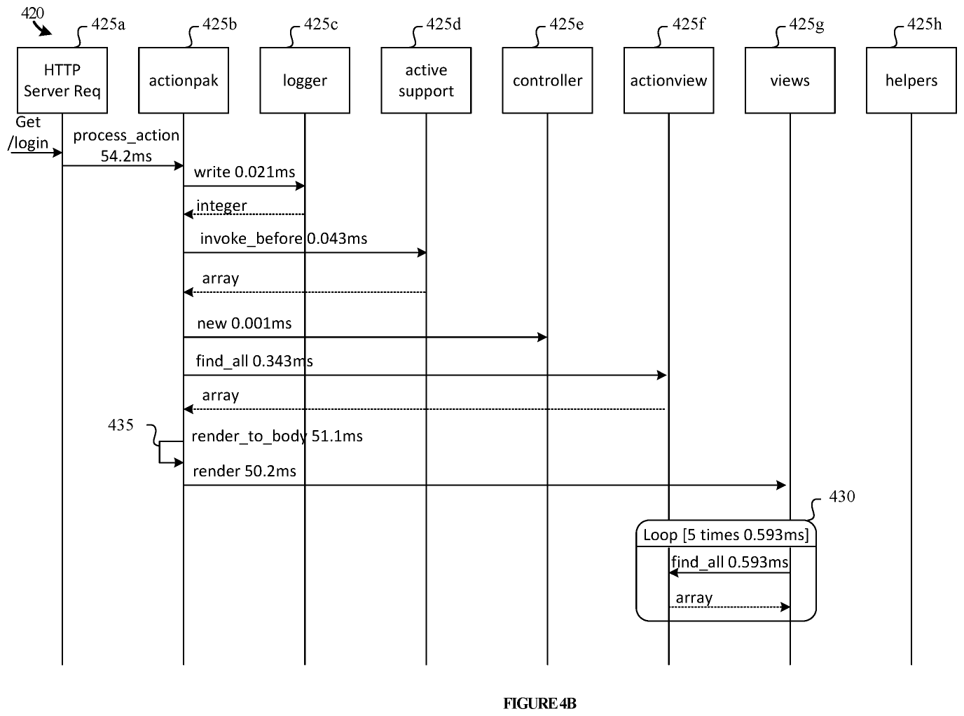

The trace files can be analyzed and interrogated to generate the behavioral model. Steps performed in codebase 105 may be labeled, and code paths connecting the steps may be labeled. Functional areas of codebase 105 may further be labeled. The behavioral model can be visualized as generally depicted in the figures. The visualization of the behavioral model may include steps performed by the application, inputs and outputs from the steps, and code paths connecting the steps. The behavioral model represents the run-time behavior of codebase 105. In other words, behavioral model generation 110 analyzes execution of codebase 105, within a testing environment, to generate a representation of the run-time behavior of codebase 105. Example visual depictions of a behavioral model are illustrated in FIGS. 4A and 4B described below. In some embodiments, a functional behavior of codebase 105 may be generated. The functional areas of codebase 105 may be labeled, and a visual depiction may include elements for the functional areas of the codebase 105 that have a size related to the density of the underlying code for the functional area. For example, various functional areas may include APIs, security, web services, user input elements, and the like.

Behavioral model interrogation 115 probes the behavioral model generated by behavioral model generation 110 to identify run-time complications during the execution of codebase 105. The interrogation of the behavioral model uses a variety of sources to classify run-time complications. For example, common problem patterns in coding environments may be used to identify run-time complications. Behavioral model interrogation 115 compares these problem patterns to the generated behavioral model to identify recognized problem patterns within codebase 105. Examples sources in which problem patterns are collected include the MITRE common weaknesses enumeration (CWE) reports as well as other reports developed by site reliability engineers, development operation engineers, or qualified individuals of the like. MITRE CWE reports are a predefined list of common software weaknesses and flaws developed by an outside corporation which primarily detail static software problems and security issues. Reports developed by individual engineers detail common performance flaws along with their root cause to identify dynamic software complications within the behavioral model. In some embodiments, artificial intelligence may be used to identify run-time complications. For example, machine learning models may be applied that identify memory leaks, inefficient data access, improper access control, and other design flaws that otherwise do not become apparent until codebase 105 is deployed in a production environment.

Once run-time complications are identified, corresponding recommended solutions may be generated. The identified run-time complications can be pinpointed in the behavioral model. The corresponding source code in codebase 105 may be identified based on the location in the behavioral model. For example, the behavioral model may include tags or other identification points that correspond to tags inserted in codebase 105. The offending source code lines may be highlighted, tagged, underlined, or otherwise flagged when viewed in a code editor. Metadata to indicate details of the identified issues may be associated with the lines or sections of the offending source code that include information such as the date the issue was introduced, a category of the issue (e.g., performance, security, failed test case, and the like), a version in which the issue was introduced, a link to connect the issue to an issue tracking system, an issue number, a link to corresponding location in the associated behavioral model, etc.). A recommended solution may be generated based on the run-time complication. In some cases, artificial intelligence (AI) may be used to generate a recommended solution. For example, a trained AI system may be configured to provide a recommended solution based on the flagged or offending source code, codebase 105 generally, the run-time complication, the behavioral model, any other information about the application, and/or a combination thereof. As one example, an AI system may be used to generate a prompt for submission to a large language model (LLM) or large multi-mode model (LMMM) (e.g., GPT-2, GPT-3, GPT-4, BLOOM, LaMDA, LLaMA, Turing, etc.). Typically, LLMs take text as input, but improvements in technology have led to LMMMs, which accept other modes of input including text, audio, video, images, and the like. In response to submitting the prompt, the LLM or LMMM may return a solution, an explanation of the issue, and the like. The AI system may tune the prompt to help ensure a valid solution is returned and may further validate the response prior to providing the solution to the user. Behavioral model interrogation 115 outputs the run-time complications and corresponding recommended solution 120. Run-time complications and corresponding recommended solutions 120 include run-time complications 121 and recommended solutions 123.

Trained AI processing may be applicable to assist with any type of predictive or determinative processing including generating the behavioral model based on the execution of the software application and the resulting data files in behavioral model generation 110, predicting the run-time complications based on the behavioral model and/or codebase 105 in behavioral model interrogation 115, and generating recommended solutions based on the behavioral model, the run-time complications, codebase 105, flagged source code, and/or the like in behavioral model interrogation 115. The trained AI processing may also assist with classification ranking and/or scoring and relevance ranking and/or scoring. For example, the ranking and ordering of run-time complications and/or recommended solutions for the run-time complications may include AI processing. The AI processing may include supervised learning, unsupervised learning, semi-supervised learning, reinforcement learning, or any other type of learning. The types of AI processing may include, for example, machine learning, neural networks, deep neural networks, and/or any other type of AI processing. Non-limiting examples may include nearest neighbor processing; naive bayes classification processing; decision trees; linear regression; support vector machines (SVM) neural networks, perceptron networks, feed forward neural networks, deep feed forward neural networks, multilayer perceptron networks, deep neural networks (DNN), convolutional neural networks (CNN), radial basis functional neural networks, recurrent neural networks (RNN), long short-term memory (LSTM) networks, sequence-to-sequence models, gated recurrent unit neural networks, auto encoder neural networks, variational auto encoder neural networks, denoising auto encoder neural networks, sparse auto encoder neural networks, Markov chain neural networks, Hopfield neural networks, Boltzmann machine neural networks, restricted Boltzmann machine neural networks, deep belief networks, deep convolutional networks, deconvolutional networks, generative adversarial networks, liquid state machine neural networks, extreme learning machine neural networks, echo state networks, deep residual networks, Kohonen networks, neural turing machine neural networks, modular neural networks, transformers, clustering processing including k-means for clustering problems, hierarchical clustering, mixture modeling, application of association rule learning, application of latent variable modeling, anomaly detection, assumption determination processing; generative modeling; low-density separation processing and graph-based method processing, value-based processing, policy-based processing, model-based processing, and the like.

Run-time complications 121 may include a list of observed complications which may be identified during the interrogation of the behavioral model in behavioral model interrogation 115 by identifying the observed complications' corresponding problem pattern. Behavioral model interrogation 115, through the interrogation of the behavioral model and codebase 105, can identify complications that may not become apparent until the application is deployed at production scale and that may not be apparent in a typical testing environment prior to the present technology. Example run-time complications 121 may include, but are not limited to memory leaks, security issues, performance issues, inefficient data access, improper access control, and the like.

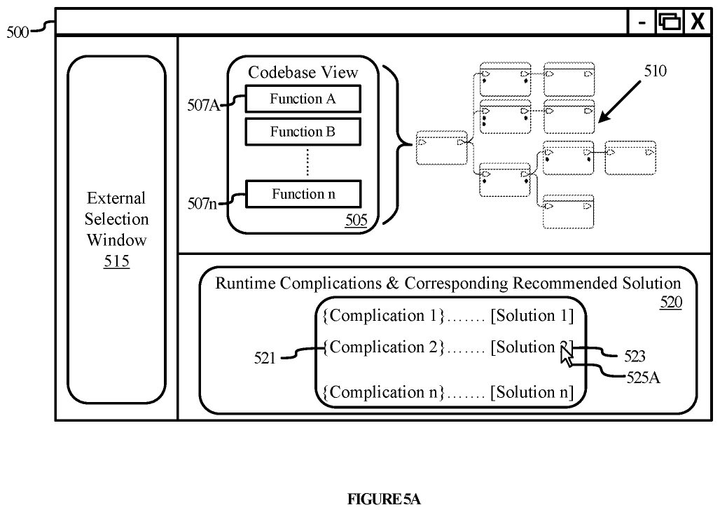

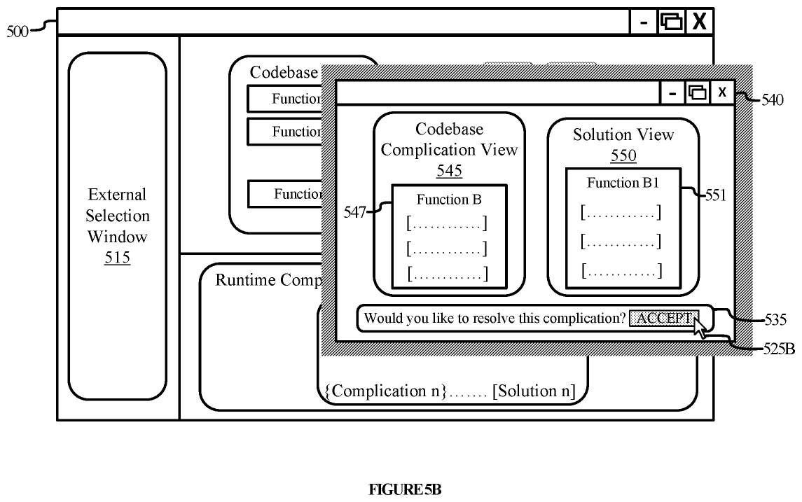

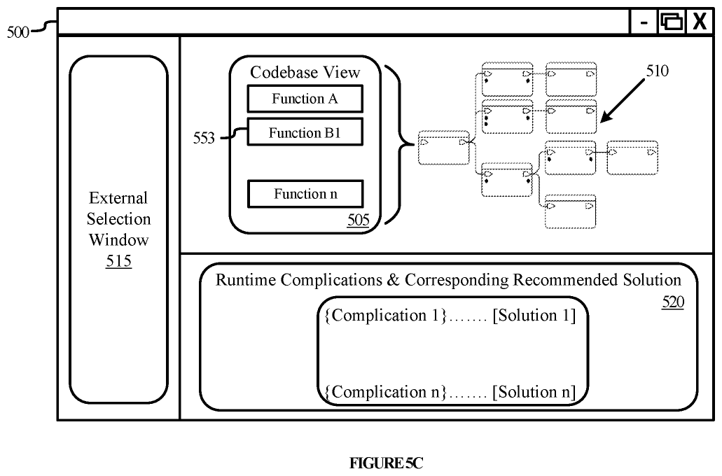

Recommended solutions 123 may include at least one solution corresponding to run-time complications 121. In an implementation, recommended solutions 123 includes a replacement code snippet to resolve the identified run-time complication in codebase 105 as depicted in FIG. 5C. In another implementation, recommended solutions 123 include one or more links to an external site containing a reference page related to details and possible solutions of the identified run-time complication.

Run-time complications and corresponding recommended solutions 120 may be provided in a user interface as depicted in examples shown in FIGS. 5A-5C.

FIG. 2 illustrates computing device 200 for a run-time complication identifier of a codebase in a local implementation for downloadable embodiments. Computing device 200 includes a processing unit such as processor 205 responsible for reading computer readable storage media such as memory 210. Computing device 200 may be any computing device that can download and execute software for performing functions to execute the logical data flow 100 of FIG. 1. For example, computing device 200 may be a server, personal computer, laptop, server farm, distributed computing environment, or the like. Computing device 200 may be, for example the same as computing device 701 of FIG. 7, which depicts additional functionality of a standard computing device excluded from device 200 for ease of description.

Memory 210 includes codebase 211, execution data, 212, behavioral models 213, problem patterns 215, metadata 217, and application 220. Codebase 211 may be the same as codebase 105 of FIG. 1. Codebase 211 is provided as the codebase 211 for analysis. Codebase 211 may be user uploaded, stored on device 200 for testing, or otherwise supplied to device 200. Codebase 211 may be collected using a user interface of application 220. Application 220 performs the functions for executing the logical data flow 100 described with respect to FIG. 1 to identify run-time complications within codebase 211 and provide recommended solutions for at least one of the identified run-time complications.

Execution data 212 represents operational definitions that specify the behavior of elements of a specific coding language (e.g., JAVA, RUBY, etc.). For example, execution data 212 may include test cases for executing codebase 211, information for generating synthetic traffic, data for defining code blocks for specific code block execution, data for defining specific processes for execution, and the like.

Behavioral models 213 represents a run-time analysis of codebase 211 and includes operational details and events observed while executing codebase 211. Behavioral models 213 may include elements that were generated based on recordings, trace files, error logs, diagnostic logs, and the like. Behavioral models 213 are generated by behavioral model generation module 223.

Metadata 217 may represent metadata collected or generated in identifying issues, solutions, or both. For example, the metadata may include recency information about identified run-time complications such as a version the issue was introduced in or a date the issue was introduced. Metadata 217 may also include a category of the issue (e.g., performance issue, security issue, failed test case, or the like), connection information to connect to an issue tracking system, an issue number, a type of flag to use for visualizing the issue (e.g., a squiggle underline, a straight underline, highlighting, a pin, or the like), solution information for identified complications, or any other relevant data associated with the specific portion of the codebase or the specific portion of the behavioral model associated with the identified issue.

Application 220 may provide a user interface based on user interface module 221. The user may, for example, provide access to codebase 211 for analysis and run-time complication identification and solution generation. Application 220 includes user interface module 221, behavioral model generation module 223, behavioral model interrogation module 225, and solution generation module 227. In an implementation, a user interacts with computing device 200 through user interface module 221. The user may provide access to codebase 211 using the user interface. Codebase 211 may be stored in memory 210 if not previously stored. Accordingly, processor 205 may execute codebase 211 when in memory 210. Processor 205 may further execute application 220 to generate and interrogate a behavioral model of codebase 211 and provide recommended solutions which mitigate at least one identified run-time complication as described in more detail below.

In an implementation, application 220 generates a behavioral model of codebase 211 using behavioral model generation module 223. The behavioral model generation module 223 may generate the behavioral model as described with respect to behavioral model generation 110 of FIG. 1. The behavioral model may be stored in behavioral models 213 of memory 210. The generated behavioral model depicts a run-time behavior of codebase 211.

Application 220 may interrogate the generated behavioral model 213 to identify run-time complications within codebase 211 using behavioral model interrogation module 225. In some embodiments, behavioral model interrogation module 225 obtains the generated behavioral model 213 and compares this model to problem patterns 215. Problem patterns 215 may include a predefined set of common error patterns found within codebases as described with respect to FIG. 1. Such patterns may include a variety of types which define both static and dynamic problem patterns. By comparing problem patterns 215 to the generated behavioral model, behavioral model interrogation module 225 is able to identify problem patterns within the behavioral model 213. The identification of these problem patterns within the behavioral model 213 may result in the identification of run-time complications within codebase 211. In some embodiments, AI processing may be used to interrogate the behavioral model 213 and/or codebase 211 to identify problem patterns, anomalies, discrepancies, and other errors and design flaws.

Upon predicting the potential run-time complications within codebase 211, application 220 may generate recommended solutions for the run-time complications using solution generation module 227. The recommended solutions may mitigate the run-time complications by providing the recommended solution that the user may implement in codebase 211. Solution generation module 227 may generate one or more solutions corresponding to an identified run-time complication such as recommended solution 123 described with respect to FIG. 1. The recommended solutions generated from solution generation module 227 may include a code snippet to replace a portion of the source code in codebase 211 and/or information about the run-time complication that can be used to address the design flaw causing the run-time complication. The code snippet and/or other information may be provided using a popup window, a link to an external source, a link to a different page within application 220, and/or the like.

FIG. 3 illustrates operating environment 300 that may include a cloud-based system to perform the run-time complication identification for a codebase in an implementation served by a cloud-based service. Operating environment 300 includes interface 305, behavioral model generation module 310, behavioral model interrogation module 315, solution generation module 320, storage 325, and user equipment 330. Operating environment 300 represents an example environment in which logical data flow 100 of FIG. 1 may be executed. A local embodiment in FIG. 2 is shown and a cloud-based embodiment in FIG. 3 is shown, but the specific implementation of the functionality described herein does not depart from the scope of the description, whether performed via a local embodiment or a cloud-based embodiment, using a single computing system or multiple computing systems.

Interface 305 represents a cloud-based interface to make online services accessible for identifying run-time complications within a codebase. In an implementation, interface 305 makes the online services described herein accessible via a user interface 331 on user equipment 330. Interface 305 may communicate with modules 310, 315, and 320, as well as storage 325 to facilitate generating run-time complications and recommended solutions for the user's codebase and provide results to the user via user interface 331. Interface 305 may be software that executes on a cloud-based server. Interface 305 may be executed on a same server or a different server than the server(s) executing the behavioral model generation module 310, behavioral model interrogation module 315, and solution generation module 320. Interface 305 may be executed on a server or computing system accessible by behavioral model interrogation module 315, behavioral model generation module 310, storage 325, solution generation module 320, or a combination thereof.

Behavioral model generation module 310 generates a visual representation of the user's codebase in operation. Behavioral model generation module 310 monitors one or more run-time operations of user equipment 330 which executes the user's uploaded or stored codebase to generate a behavioral model of the codebase in operation. Behavioral model generation module 310 may perform the behavioral model generation 110 described with respect to FIG. 1. Behavioral model generation module 310 may include instructions executed by a processor on a computing system such as a server. In an implementation, behavioral model generation module 310 may interact with storage 325 to source inputs for a behavioral model generation. Behavioral models generated by behavioral model generation module 310 can be stored in storage 325. Behavioral model generation module 310 may be executed on a same server or a different server than the server(s) executing behavioral model interrogation module 315, solution generation module 320, and interface 305. Behavioral model generation module 310 may be executed on a server or computing system accessible by interface 305, behavioral model generation module 310, storage 325, solution generation module 320, or a combination thereof.

Behavioral model interrogation module 315 interrogates the generated behavioral model to identify run-time complications within the user codebase. Behavioral model interrogation module 315 may perform the behavioral model interrogation 115 as described with respect to FIG. 1. Behavioral model interrogation module 315 may include instructions executed by a processor on a computing system such as a server. Behavioral model interrogation module 315 may interact with storage 325 to obtain problem patterns, such as the example problem patterns detailed in FIG. 1. Behavioral model interrogation module 315 may compare the obtained problem patterns with the generated behavioral model to identify run-time complications within the user codebase. If a run-time complication is identified within the user codebase, behavioral model interrogation module 315 may communicate this identified run-time complication to interface 305 and may store the data or metadata associated with the identified complication in storage 325. In some implementations, behavioral model interrogation module 315 may utilize artificial intelligence to intelligently identify run-time complications within the codebase. Behavioral model interrogation module 315 may be executed on a server or computing system accessible by interface 305, behavioral model generation module 310, storage 325, solution generation module 320, or a combination thereof. Behavioral model interrogation module 315 may be executed on a same server or a different server than the server(s) executing behavioral model generation module 310, solution generation module 320, and interface 305.

In an implementation, after a run-time complication has been identified by behavioral model interrogation module 315, interface 305 may communicate the identified run-time complication to solution generation module 320. Solution generation module 320 may provide one or more recommended solutions to the corresponding run-time complication. Solution generation module 320 may perform solution generation as described with respect to FIG. 1 such that recommended solutions produced by solution generation module 320 may include the example solutions detailed in recommended solutions 123 of FIG. 1. Solution generation module 320 may include instructions executed by a processor on a computing system such as a server. In some implementations, solution generation module 320 may utilize artificial intelligence to intelligently generate recommended solutions for the identified run-time complication, such as using an LLM or LMMM as described in more detail with respect to FIG. 1. Solution generation module 320 may interact with storage 325 to store the identified solutions or metadata associated with the corresponding issue and solution. Solution generation module 320 may be executed on a server or computing system accessible by interface 305, behavioral model generation module 310, storage 325, behavioral model interrogation module 315, or a combination thereof. Solution generation module 320 may be executed on a same server or a different server than the server(s) executing behavioral model generation module 310, behavioral model interrogation module 315, and interface 305.

Storage 325 interacts with all the online services of operating environment 300 and includes a database of memory housing user codebase uploaded from interface 305, behavioral models obtained external sources, problem patterns collected from behavioral model interrogation module 315, user account data, metadata associated with identified issues and solutions, and the like. In some implementations, a user may repeatedly interact with operating environment 300 to identify run-time complications within their codebases. For example, a user such as development operations engineer may be developing an application that requires numerous libraries to run. Throughout the development of this example application, the development operations engineer may use a debugger to identify run-time complications while the application is developed. Multiple executions of the run-time complication identifier generate data, and storage 325 can store previous user account data wherein the run-time complication identifier optimizes its performance based on past interactions with the user. In some embodiments, data regarding each run of the behavioral model generation module 310, behavioral model interrogation module 315, solution generation module 320, or any combination of them may be stored in storage 325 temporarily or permanently.

User equipment 330 (such as computing device 200 of FIG. 2) includes user interface 331. A user may utilize user interface 331 to perform a run-time complication identification and solution generation of their uploaded codebase. User interface 331 may be included in a software application installed on user equipment 330 or accessible via a web browser. User equipment 330 communicates with interface 305, to share data between the user and the online services.

In use, a user may access user equipment 330 and interact with user interface 331. Via user interface 331, the user may upload or access a codebase for analysis. The codebase may be stored in storage 325. The user interface 331 communicates with interface 305 to request analysis of the codebase based on user input into user interface 331. Interface 305 requests behavioral model generation module 310 generate a behavioral model of the codebase. In some embodiments, if a behavioral model for the codebase already exists from a prior run of the behavioral model generation module 310 for that codebase, the stored behavioral model may be accessed from storage 325. The behavioral model is generated as described with respect to behavioral model generation 110 of FIG. 1. Interface 305 may make the behavioral model accessible to the user via the user interface 331. Interface 305 or behavioral model generation module 310 may request behavioral model interrogation module 315 interrogate the behavioral model to identify run-time complications. Behavioral model interrogation module 315 may interrogate the behavioral model and identify run-time complications as described with respect to behavioral model interrogation 115 of FIG. 1. The run-time complications may be stored by behavioral model interrogation module 315 or interface 305 into storage 325. Interface 305 or behavioral model interrogation module 315 may request solutions for the run-time complications from solution generation module 320. Solution generation module 320 may generate solutions as described with respect to FIG. 1. Solution generation module 320 or interface 305 may store the solutions in storage 325. Interface 305 may make the run-time complications and recommended solutions available for the user to view via user interface 331.

FIG. 4A illustrates example visual depiction 400 of at least a portion of a behavioral model. Visual depiction 400 is a visual representation of the behavioral model. The behavioral model is generated based on a run-time operation of a codebase 405. The codebase 405 may be source code in any coding language. Examples of codebase 405 include but are not limited to web applications, locally installed applications, and applications served from a cloud. Visual depiction 400 depicts example behavioral models that behavioral model generation modules 223 and 310 of FIGS. 2 and 3 may output, respectively.

In some implementations, codebase 405 is inputted into a generation module that generates the corresponding behavioral model that represents the run-time operation of the codebase 405. The generation module may exhaustively probe the codebase 405 to identify parameters, connection points, and the like to ensure a thorough representation of the codebase 405 in operation. Codebase 405 is representative of codebase 105 in FIG. 1 as well as the codebases used to generate behavioral models of FIGS. 2 and 3.

The behavioral model may be stored as a visual depiction such as visual depiction 400 or 420, or the behavioral model may not be stored as a visual representation and may instead be stored as data representing the behavior of the codebase 405 including connection information, operational paths (e.g., codepaths), functional categories, and the like. As shown in visual depiction 400, operational paths 410A, 410B, and 410C represent the path of the codebase in operation. More specifically, operational paths 410A, 410B, and 410C detail the execution of codebase 405 functions in real-time. The code blocks 415A, 415B, 415C, 415D, 415E, 415F, 415G, 415H, 415I represent data transformations or other operations that include one or more inputs from operational paths 410 and one or more outputs to other operational paths 410.

FIG. 4B illustrates another example visual depiction 420 of at least a portion of the behavioral model. Visual depiction 400 and visual depiction 420 may both be generated from the same behavioral model. For example, when the behavioral model is stored as data, any format for the visual depiction may be used. In the example of visual depiction 420, the behavioral model is depicted as a sequence diagram.

Visual depiction 420 includes functional areas 425 including HTTP server requests 425a, actionpak 425b, logger 425c, activesupport 425d, controllers 425e, actionview 425f, views 425g, helpers 425h. Visual depiction 420 may include more or fewer functional areas 425 than depicted in this example, and the functional areas 425 may have any appropriate names. Visual depiction 420 further includes the operational paths that are generated when calls are made, including the amount of time to complete the operations. For example, the write from actionpak 425b to logger 425c took 0.021 ms. Further, loops, including loop 430 are depicted. Other helpful data depicting the behavior of the codebase may be included in visual depiction 420 including, for example, internal calls within a functional area including functional call 435.

FIGS. 5A, 5B, and 5C example user interfaces such as user interface 331 as described with respect to FIG. 3. User interface 500 allows visual access of a user to the functionality (either locally or on a cloud-based system) to intelligentially identify run-time complications and generate recommended solutions. User interface 500 includes codebase view 505, visual depiction 510 of the behavioral model (depicted visually in FIGS. 4A and 4B), external selection window 515, run-time complications & corresponding solutions window 520, and cursor 525A. User interface 500 is representative of a graphical user interface accessed via a computing device such as computing device 200 of FIG. 2 or user equipment 330 of FIG. 3. Example computing devices that provide user interface 500 include computers, tablets, phones, laptops, and the like.

In an implementation, codebase view 505 displays all the subroutines of a user codebase spanning Function A 507A through Function n 507n. These functions represent the individual subroutines that make up a codebase, such as codebase 105 of FIG. 1 or the codebases found in memory and storage of FIGS. 2 and 3, respectively. For example, Function A 507A could represent a main function module which executes different subroutines contained within the subsequent functions (i.e., Function B through Function n). While the subsequent functions, such as Function n 507n, execute subroutines of the user codebase. The language used to generate codebase in codebase view 505 may be any type of coding language and may use any programming paradigm including structured, procedural, functional, modular, or object-oriented. Accordingly, the codebase view 505 may include objects, structures, procedures, modules, or the like.

Visual depiction 510 displays to a user the visual representation of their codebase in operation by providing a visual depiction of the behavioral model. Visual depiction 510 can be generated locally, as displayed in FIG. 2, or within a cloud-based system, as displayed in FIG. 3. After the generation of visual depiction 510, user interface 500 displays the run-time depiction of the codebase to the user.

In an implementation, external selection window 515 displays various options within user interface 500. User interface 500 provides access to an application, so external selection window 515 may display various abilities allowed in the application. Examples may include options to select other user codebases, options to generate and interrogate a behavioral model, and the like.

Similar to FIG. 1, run-time complications & corresponding recommended solutions 520 depict a list of run-time complications within the codebase (e.g., generated by behavioral model interrogation module 315 of FIG. 3), including run-time complication 521, as well as a list of at least one corresponding solution (e.g., generated by solution generation module 320 of FIG. 3), including recommended solution 523, to either resolve or mitigate these complications. Example run-time complications may include memory leaks, security issues, performance issues, inefficient data access, improper access control, and the like. Within run-time complications & corresponding recommended solutions 520, the user is able to select different solutions with cursor 525A. The selection of recommended solution 523 with cursor 525A results in generating a pop-up window described with respect to FIG. 5B.

Upon the user selection of a recommended solution, as detailed in FIG. 5A, user interface 500 may display pop-up window 540 illustrated in FIG. 5B. Pop-up window 540 includes codebase complication view 545, solution view 550, and user option 535.

In an implementation, codebase complication view 545 displays the identified run-time complication that was found during the interrogation of behavioral model. Codebase complication view 545 includes identified run-time complication 547 that is within a specific code segment (e.g., function, object, etc.) of the codebase. Identified run-time complication 547 displays the source for the run-time complication within the codebase.

In an implementation, solution view 550 includes code snippet 551 to replace identified run-time complication 547 within the codebase. Code snippet 551 provides a replacement code segment (e.g., function, object, etc.) to resolve the identified issue of the original code segment within the codebase. The user is able to interact with user option 535 where selecting ACCEPT with cursor 525B results in the replacement of identified run-time complication 547 with code snippet 551. Pop-up window 540 is exemplary in format and implementation. For example, a new page may be shown, or a new window opened, rather than a popup window. Further the format of the complication and solution may differ without departing from the spirit of the disclosure.

FIG. 5C illustrates the updated user interface upon the user accepting the replacement code snippet to resolve the identified run-time complication within the codebase. In this updated view, user interface 500 now displays codebase view 505 with updated function 553. Updated function 553 includes an updated version of the original function, which includes code snippet 551 which resolves the run-time complication that was identified within the original function. In conjunction with updating codebase view 505, run-time complications & corresponding recommended solutions 520 updates to remove the now resolved complication. In some embodiments, undo features may be provided to cancel replacement of the code snippet. In some embodiments, a window showing the replacements that have been accepted may be provided for review.

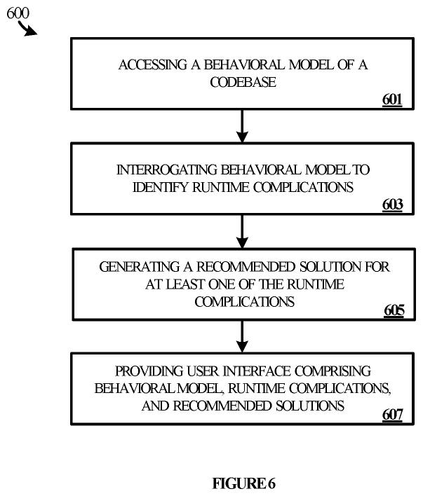

FIG. 6 illustrates a method 600 for identifying run-time complications and recommended solutions. Method 600 may be implemented on software, hardware, or any combination thereof. For example, method 600 can be executed on or by components of computing device 200 of FIG. 2 or of operating environment 300 of FIG. 3.

In operation 601, a system accesses a behavioral model (e.g., depicted by visual depictions 400, 510) of a codebase (e.g., codebase 104, 211, 405). For example, device 200 may access the behavioral model from behavioral models 213 or the server implementing interface 305 may access the behavioral model from storage 325. The behavioral model may be generated by behavioral model generation as described with respect to behavioral model generation 110 and behavioral model generation module 223, 310. The behavioral model is a run-time representation of the codebase generated based on a thorough or exhaustive probing of the codebase using extensive test scripts, artificial intelligence (AI) networks, or any other method of probing a codebase during runtime to generate an exhaustive analysis of run-time behavior of the codebase.

In operation 603, the system interrogates the behavioral model to identify run-time complications within the codebase. Behavioral model interrogation 115 may be performed by behavioral model interrogation module 225 or 315. The system interrogates the behavioral model to identify complications by, for example, comparing the behavioral model to a predefined set of problem patterns. These problem patterns identify both static and dynamic complications related to security, production, and the like. If a problem pattern is identified within the behavioral model, a run-time complication is identified within codebase 105. In some embodiments, AI models are used to interrogate the behavioral model. When complications are found, they may be stored in association with the codebase, for example, in storage 325 or memory 210.

In operation 605, responsive to the behavioral model interrogation producing the identified run-time complications, the system generates a recommended solution for at least one of the run-time complications identified during interrogation. In some embodiments, recommended solutions are identified for every identified complication. In some embodiments, a recommended solution is not identified for every identified complication. The behavioral model interrogation (e.g., behavioral model interrogation 115 performed by behavioral model interrogation module 225 or 315) identifies the run-time complications 121, and the recommended solutions 123 are identified by, for example, solution generation module 227 or 320. Recommended solutions may include a code snippet to replace the identified run-time complication in the codebase, as demonstrated in FIGS. 5A, 5B, and 5C, or a link to an external site with information, such as a reference page, related to the identified run-time complication details possible solutions as well as other information related to the run-time complication.

In operation 607, the system provides a user interface, such as user interface 500, that includes the generated behavioral model, the identified run-time complications, and at least one recommended solution corresponding to the run-time complications. For example, as shown in FIG. 5A, the user interface 500 includes the visual depiction 510 of the behavioral model and the run-time complications list and the corresponding recommended solutions 520. The user interface may include other tools and information including, for example, a view of the codebase, tools for searching, options for selection of displayed items for more information (e.g., selection of recommended solution 523 generates a pop-up window 540 shown in FIG. 5B), and other options helpful in software debugging applications.

FIG. 7 illustrates computing device 701 that is representative of any system or collection of systems in which the various processes, programs, services, and scenarios disclosed herein may be implemented. Examples of computing device 701 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof. Computing device 701 may be device 200, user equipment 330, computing devices that implement cloud services including behavioral model generation module 310, behavioral model interrogation module 315, solution generation module 320 interface 305 or storage 325, a computing device that implements user interface 500, or a computing device that implements method 600.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements run-time analysis process 706, which includes the behavioral model generation (e.g., behavioral model generation 110, behavioral model generation module 223, 310) of a codebase (e.g., codebase 105, 211, 405), the behavioral model interrogation (e.g., behavioral model interrogation 115, behavioral model interrogation module 225, 315) to identify the run-time complications (e.g., run-time complications 121), and the solution generation (e.g., recommended solutions 123 by solution generation module 227, 320). When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise any type of processor (e.g., a micro-processor) and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. In other words, the computer readable storage media is a non-transitory computer readable media.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or other systems.

Software 705 (including run-time analysis process 706) may be implemented in program instructions and among other functions may, when executed by processing system 702, direct processing system 702 to operate as described with respect to the various operational scenarios, sequences, and processes illustrated herein. For example, software 705 may include program instructions for implementing a multipoint format process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support the described runtime analysis of a codebase to identify run-time complications and recommended solutions. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of such productivity applications, they apply as well to other contexts such as gaming applications, virtual and augmented reality applications, business applications, and other types of software applications. Likewise, the concepts apply not just to electronic documents, but to other types of content such as in-game electronic content, virtual and augmented content, databases, and audio and video content.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method, comprising:
accessing a behavioral model of a codebase, wherein the behavioral model represents a run-time behavior of the codebase generated based on a run-time analysis of the codebase;
interrogating the behavioral model to predict run-time complications within the codebase;
generating a recommended solution for at least one of the run-time complications; and
providing a user interface comprising the behavioral model, a listing of the run-time complications, and the recommended solution.

2. The method of claim 1, wherein interrogating the behavioral model comprises identifying problem patterns within the codebase.

3. The method of claim 1, wherein the run-time complications comprise design flaws that become apparent in production during run-time.

4. The method of claim 3, wherein interrogating the behavioral model further comprises applying artificial intelligence that can recommend solutions to the design flaws based on the behavioral model of the codebase.

5. The method of claim 1, further comprising generating the behavioral model based on recording an execution of the codebase.

6. The method of claim 1, wherein at least one of the run-time complications comprises one of a memory leak, inefficient data access, and improper access control.

7. The method of claim 1, wherein interrogating the behavioral model comprises assigning a probability score to each of the run-time complications based on a probability that the respective run-time complication will arise in production during run-time.

8. The method of claim 7, wherein interrogating the behavioral model further comprises:
ranking the run-time complications based on the probability score; and
ordering, in the user interface, the run-time complications based on the ranking.

9. The method of claim 1, wherein the recommended solution comprises a code snippet to replace a portion of the codebase comprising a design flaw that causes at least one of the run-time complications.

10. A system comprising:
one or more processors; and
a memory operatively coupled with the one or more processors, the memory having stored thereon instructions that, upon execution by the one or more processors, cause the one or more processors to:
access a behavioral model of a codebase, wherein the behavioral model represents a run-time behavior of the codebase generated based on a run-time analysis of the codebase;
interrogate the behavioral model to predict run-time complications within the codebase;
generate a recommended solution for at least one of the run-time complications; and
provide a user interface comprising the behavioral model, a listing of the run-time complications, and the recommended solution.

11. The system of claim 10, wherein the instructions to interrogate the behavioral model comprise further instructions that, upon execution by the one or more processors, cause the one or more processors to identify problem patterns within the codebase.

12. The system of claim 10, wherein the run-time complications comprise design flaws that become apparent in production during run-time.

13. The system of claim 12, wherein the instructions to interrogate the behavioral model comprise further instructions that, upon execution by the one or more processors, cause the one or more processors to apply artificial intelligence that can recommend solutions to the design flaws based on the behavioral model of the codebase.

14. The system of claim 10, wherein the instructions comprise further instructions that, upon execution by the one or more processors, cause the one or more processors to generate the behavioral model based on recording an execution of the codebase.

15. The system of claim 10, wherein at least one of the run-time complications comprises one of a memory leak, inefficient data access, and improper access control.

16. The system of claim 10, wherein the instructions to interrogate the behavioral model comprise further instructions that, upon execution by the one or more processors, cause the one or more processors to assign a probability score to each of the run-time complications based on a probability that the respective run-time complication will arise in production during run-time.

17. The system of claim 16, wherein the instructions to interrogate the behavioral model comprise further instructions that, upon execution by the one or more processors, cause the one or more processors to:
rank the run-time complications based on the probability score; and
order, in the user interface, the run-time complications based on the rank.

18. The system of claim 10, wherein the recommended solution comprises a code snippet to replace a portion of the codebase comprising a design flaw that causes at least one of the run-time complications.

19. A computer-readable media device having stored thereon instructions that, upon execution by one or more processors, cause the one or more processors to:
access a behavioral model of a codebase, wherein the behavioral model represents a run-time behavior of the codebase generated based on a run-time analysis of the codebase;
interrogate the behavioral model to predict run-time complications within the codebase;
generate a recommended solution for at least one of the run-time complications; and
provide a user interface comprising the behavioral model, a listing of the run-time complications, and the recommended solution.

20. The computer-readable media device of claim 19, wherein the run-time complications comprise design flaws that become apparent in production during run-time, and wherein the instructions comprise further instructions that, upon execution by the one or more processors, cause the one or more processors to identify problem patterns within the codebase.
